(19) United States
(12) Patent Application Publication
(10) Pub. No.: US 2006/0232016 A1
(43) Pub. Date: Oct. 19, 2006

(54) Metal flat gasket

(76) Inventors: Christoph Hilgert, Overath (DE); Daniel J. Vialard, Novi, MI (US)

Correspondence Address: Robert L. Stearns;Dickinson Wright, 38525 Woodward Avenue, Bloomfield Hills, MI, 48304-2970, US

(21) Appl. No.: 10/568,575

(22) PCT Filed: Jul. 22, 2004
(86) PCT No.: PCT/DE04/01638

§ 371 Date: Feb. 16, 2006

(30) Foreign Application Priority Data
Aug. 16, 2003 (DE) 103 37 677.1

(51) Int. Cl. F02F 11/00

(52) U.S. Cl. 277/593

(57) ABSTRACT

The invention relates to a metal flat gasket, especially cylinder head gasket, for an internal combustion engine. The gasket comprises at least one functional layer having at least one through-opening, and at least one leveling and/or cover layer covering the functional layer at least partially. When the gasket is not yet mounted the functional layer is configured as a planar sheet metal element which is associated, at least in the area of the through-opening, with at least one profiled element. When the gasket is mounted the profiled element deforms the functional layer, thereby producing at least one elastically sealing area.

This invention relates to a metal gasket, in particular a cylinder head gasket for internal combustion engines.

Cylinder head gaskets made from steel normally achieve their sealing capacity through linear areas of increased compression. Typically, functional elements such as full beads, half beads, stoppers, plastic stoppers, etc. create the compression lines. To achieve the sealing function, the functional elements require a specific projection beyond the thickness of the remaining gasket surface. Furthermore, a certain amount of resiliency is necessary to conform to possible deflections of the sealing gap. The placement of these beads requires a high tooling cost that is frequently associated with long wait times until the creation of the seal.

In [European patent] EP 306 750A, a cylinder head gasket can be seen that functions jointly with a fire ring. Beneath the profiled body a cutout is provided in order to permit an elastic deformation of the metal layer. No stopper elements are provided.

The [German] patent DE 14 25 524A discloses a gasket that possesses elastic sealing beads in the individual layers. As a result of the beads, the gasket deforms in the assembled state. No stopper elements are provided here, either.

The U.S. Pat. No. 3,090,019A discloses a gasket in the shape of a stamped ring inlay that can function jointly with multiple ring inlays. A functional layer between the ring inlays deforms in the assembled state.

Stopper elements, which work together with a leveling layer, cannot be found in this disclosure.

A metal gasket is disclosed in EP B 0369 033. This is comprised of an individual base plate that is supplied with at least one opening and that possesses two parallel, flat, face surfaces. On both sides of the face surfaces, in the area of the through-opening, sealing material of greatly varying shapes are applied.

To these, overlays can be assigned on the through-opening sides that possess a lower axial height than the sealing material. The intended effect of the sealing materials is to cause, with the clamping in the assembled state, a deformation of the base plate between the sealing areas. Only a single layer metal gasket is described here, where the applied sealing materials are typically softer than the metal used, so that it is questionable how much of the intended effect of the deformation of the metal layer in the area of the sealing elements will in fact occur.

The object of the invention is to further develop a metal gasket, in particular a cylinder head gasket for internal combustion engines, so that the production costs can be reduced and at the same time, in the area of the deformation, in addition to the given elasticity, there is also a definable ability to reset.

This objective is fulfilled according to the invention by the characteristics of patent claims 1 and 11.

Advantageous further developments of the objectives of the invention can be seen in the additional claims.

The profiled body consists, according to further intentions of the invention, of incompressible material. Metal or plastics are considered here.

Through the object of the invention a multi-layer gasket, in particular a cylinder head gasket, is created where during the assembly, the otherwise usual insertion of beads in the functional layers is unnecessary. Accordingly, the tooling costs and the production time can be reduced substantially. With the object of the invention, it is now possible with multi-layer metal gaskets, in particular cylinder head gaskets, to accomplish a multitude of constructive assemblies that are useful in almost every practical application.

One or more functional layers, that are flat before assembly, are for instance, supplied with a leveling layer on both sides. The leveling layers do not completely cover the functional layers, but in each case, on only one side of the desired compression line. As a result of this arrangement, the functional layers are being compressed in a bead-like form (half bead / full bead) by the assembly process. In this case, the bead has the intention to revert to the original flat state, i.e. it shows elasticity and the ability to reset.

Using spring steel for the functional layer can increase these measures.

The leveling layers can be of different thickness where for example, a leveling layer can also take on the function of a stopper. In addition, several leveling layers can be arranged on one side of the functional layer where an offset has to be maintained to the leveling layer on the other side, or respectively as the case may be, to further functional layers.

Instead of the applied leveling layers, cover layers can be provided that are appropriately supplied with a profile. Combinations of leveling and cover layers are also possible.

The object of the invention is illustrated in the drawing using an embodiment and is described as follows:

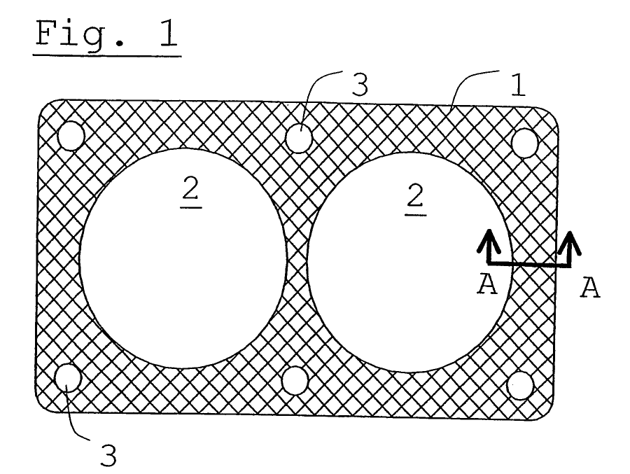

FIG. 1 Top view of a cylinder head gasket;

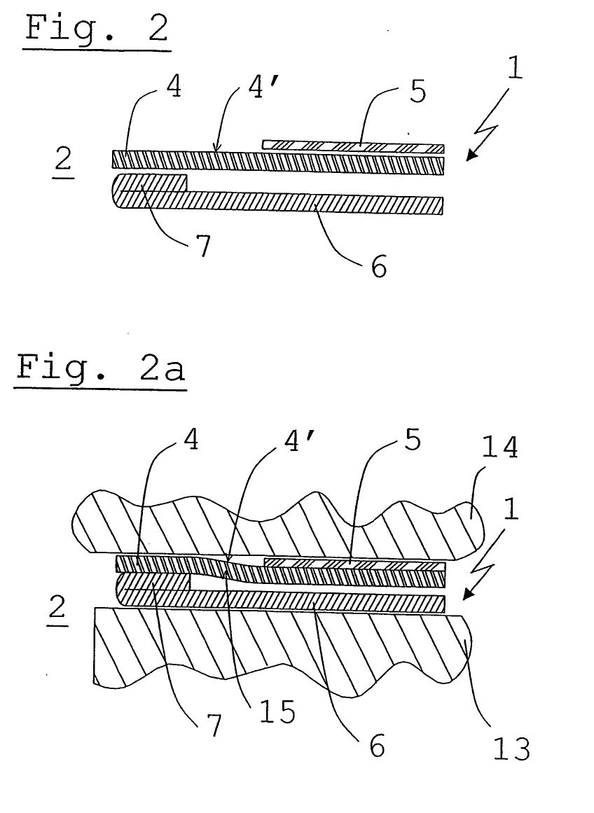

FIGS. 2 to 10 Various constructive assemblies of a cylinder head gasket, cut along line A-A of FIG. 1;

FIGS. 2a to 10a Construction configuration of various constructive assemblies of a cylinder head gasket according to FIGS. 2 to 10 in compressed state between the cylinder block and the cylinder head

FIG. 1 shows a cylinder head gasket 1, in this example with two through-openings 2, as well as several bolt through-holes 3. The cylinder head gasket 1, is—as shown in the following figures—constructed of multiple layers, where a great variety of configurations is possible.

FIGS. 2 to 10 show such varying constructions where the cuts are, in each case, along the line A-A of FIG. 1.

FIG. 2 shows a functional layer 4, a leveling layer 5, as well as in the area of the through-opening 2, a provided metal ring element 6, that is supplied with a flange stopper element 7 that forms a profiled body. The functional layer 4 is made from spring steel. The leveling layer 5 is supplied on the surface 4′ of the functional layer 4 that is facing away from the stopper element 7.

FIG. 2a shows the compressed state of the cylinder head gasket 1, between the cylinder block 13 and cylinder head 14 according to FIG. 2. As a consequence of the compression of the layers 4, 5, and 6, the stopper 7 with the leveling layer 5 causes a deformation of the functional layer 4 that creates a sealing area 15, in the form of a half bead, with an elastic effect.

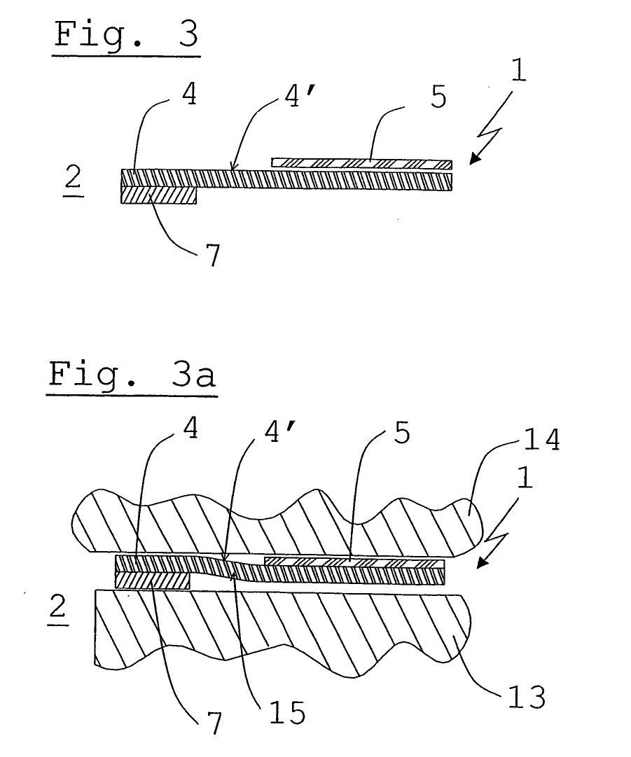

FIG. 3 show an alternative, namely a functional layer 4, a leveling layer 5, as well as, attached to functional layer 4, a stopper element 7, which consists of plastic, and which forms a profiled body. Here too, the leveling layer 5 is placed on the surface 4′ of the functional layer 4 that is facing away from the stopper element 7.

FIG. 3a shows the compressed state of the cylinder head gasket 1 between the cylinder block 13 and the cylinder head 14 according to FIG. 3. As a consequence of the compression of the layers 4 and 5, the stopper element 7 with the leveling layer 5 causes a deformation of the functional layer 4 through which a sealing area 15, with elastic effect is formed also as a half bead.

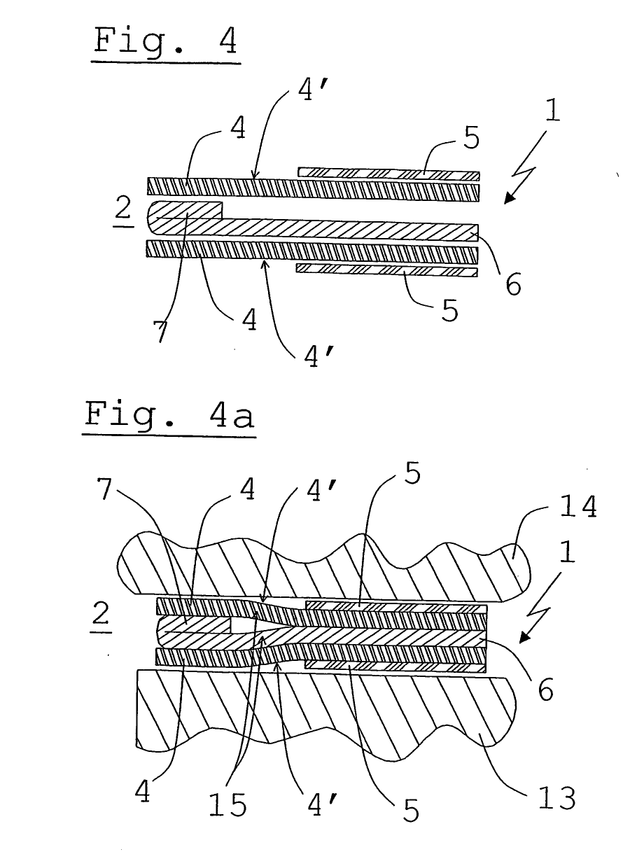

FIG. 4 show two functional layers 4, the ring element 6, with stopper element 7, as well as two leveling layers 5, placed in the area outside the profile-building stopper element 7.

FIG. 4a shows the compressed state of the cylinder head gasket 1 between the cylinder block 13 and the cylinder head 14 according to FIG. 4. As a consequence of the compression of the two functional layers 4 and the two leveling layers 5, the stopper element 7 with the two leveling layers 5 causes a deformation in the functional layers 4 that forms a sealing area 15 with elastic effect.

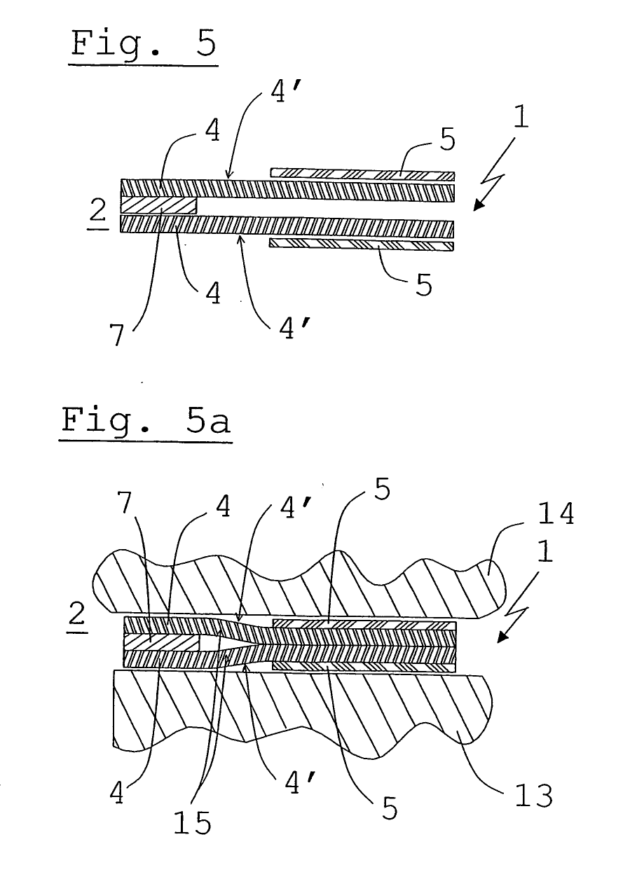

FIG. 5 also shows two functional layers 4 with leveling layers 5 as well as a stopper element 7 that is envisioned between the functional layers 4 and that forms a profiled body.

FIG. 5a shows the compressed state of the cylinder head gasket 1 between the cylinder block 13 and the cylinder head 14 according to FIG. 5. As a consequence of the compression of the two functional layers 4 and the two leveling layers 5 the stopper element 7 that forms a profiled body, with the two leveling layers 5, causes a deformation of the functional layer 4 that forms a sealing area 15 with elastic effect.

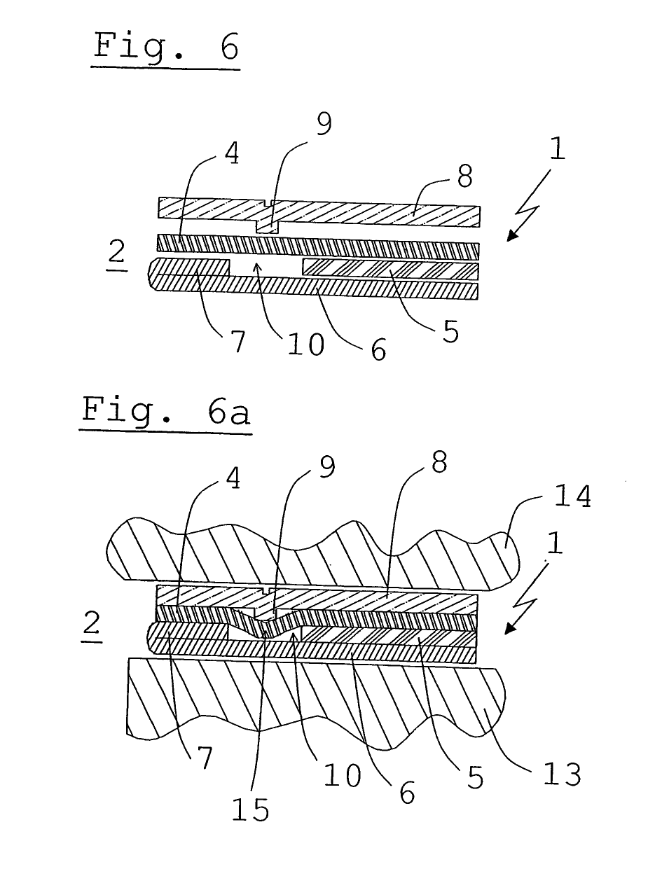

FIG. 6 shows a further alternative. A functional layer 4, a leveling layer 5, a cover layer 8, are supplied, as well as the metal ring element 6 that has already been mentioned in FIGS. 2 and 4, with the stopper element 7. In this example, the cover layer 8, on the side facing the functional layer, shows a profiled body 9, that is placed opposite the cutout 10 that is provided between stopper element 7 and leveling layer 5.

FIG. 6a shows the compressed state of the cylinder head gasket 1 between the cylinder block 13 and the cylinder head 14 according to FIG. 6. During the compression of the functional layer 4, the leveling layer 5, the cover layer 8 with the profiled body 9, and the ring element 6 with the stopper element 7, the functional layer 4, consisting of spring steel, is being pushed in the direction of the ring element 6 forming a bead-like—in this case a full bead—sealing area 15 with elastic effect.

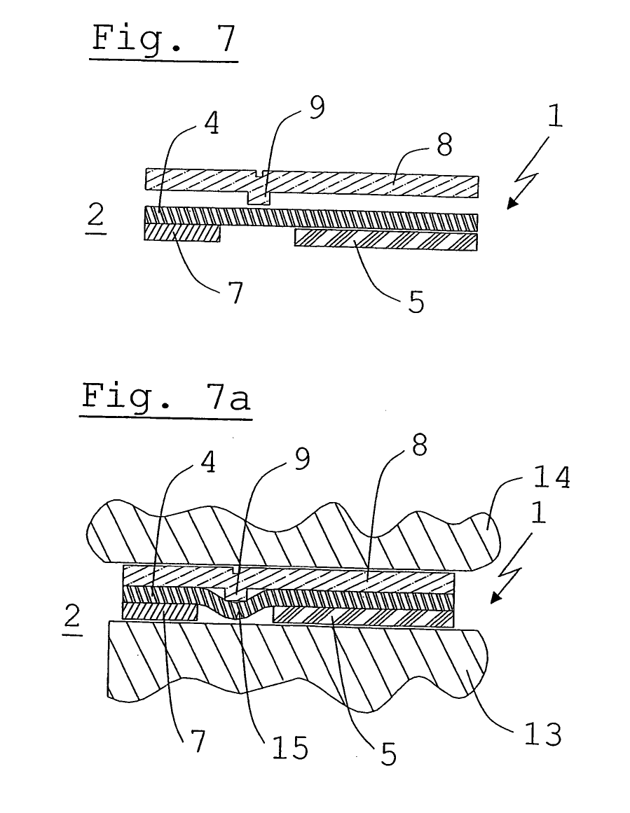

FIG. 7 contains a functional layer 4, a leveling layer 5, a cover layer 8 as well as stopper element 7. Furthermore a profiled body 9 is placed in the cover layer 8.

FIG. 7a shows the compressed state of the cylinder head gasket 1 between the cylinder block 13 and the cylinder head 14 according to FIG. 7. As a consequence of the compression of the functional layer 4, the leveling layer 5, and the cover layer 8, the profiled body 9 placed in the cover layer, the stopper element 7, and the leveling layer 5 cause a deformation of the functional layer 4 that forms a sealing area 15 with elastic effect.

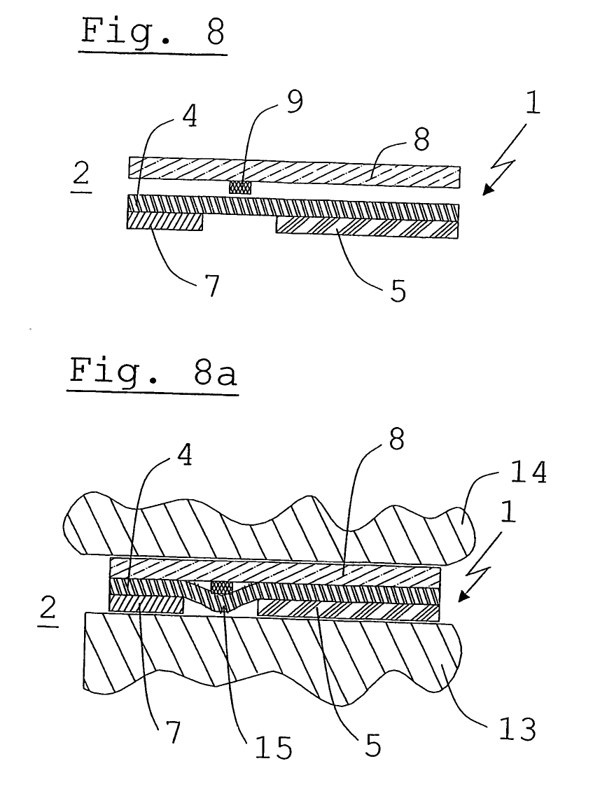

FIG. 8 contains a functional layer 4, a leveling layer 5, a cover layer 8, as well as a stopper element 7. In contrast to FIG. 7, the profiled body 9 is connected as a separate part to the cover layer 8.

FIG. 8a shows the compressed state of the cylinder head gasket 1 between the cylinder block 13 and the cylinder head 14 according to FIG. 8. As a consequence of the compression of the functional layer 4, the leveling layer 5, and the cover layer 8, the profiled body 9, the stopper element 7, and the leveling layer 5 cause a deformation of the functional layer 4 that forms a sealing area 15 with elastic effect.

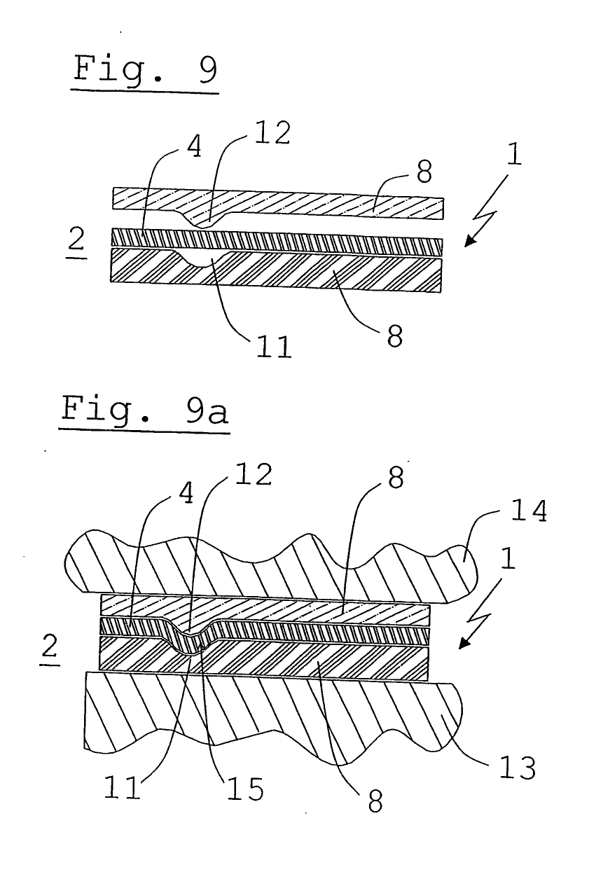

FIG. 9 contains a functional layer 4 and two cover layers 8. The functional layer 4, in its pre-assembled state, is formed as a flat spring steel element.

The lower cover layer 8 shows a groove 11 whereas the upper cover layer 8 is supplied with an integrated profiled body 12 located opposite the groove 11.

FIG. 9a shows the compressed state of the cylinder head gasket 1 between the cylinder block 13 and the cylinder head 14 according to FIG. 9. During compression of the functional layer 4 and the two cover layers 8, a material deformation of functional layer 4 in the area of the groove 1 1 and the profiled body 12 occurs so that an elastic sealing area 15 is formed.

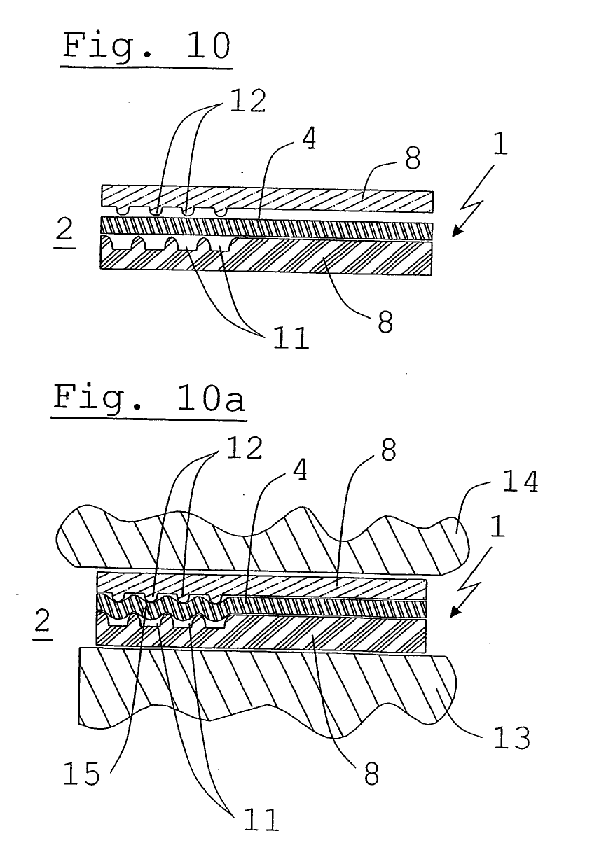

A further alternative is shown in FIG. 10. Here too, a functional layer 4 and two cover layers 8 are given. The lower cover layer 8 is supplied with several cutouts 11 located adjacent to each other whereas the upper cover layer 8 is equipped with integrated profiled bodies 12 located opposite to the respective cutouts 1 1.

FIG. 10a shows the compressed state of the cylinder head gasket 1 between the cylinder block 13 and the cylinder head 14 according to FIG. 10. The deformation of the functional layer 4, consisting of spring steel, occurs in analogy to FIG. 9a so that here too, an elastic sealing area 15 is being formed.

1. A metal gasket, in particular a cylinder head gasket for internal combustion engines, comprising at least one functional layer showing at least one through-opening, as well as at least one leveling layer and/or cover layer that covers the functional layer at least partially; where the functional layer, in the pre-assembled state of the gasket, is formed as a flat piece of metal to which is assigned, at least in the area of the through-opening, at least one profiled body through which in the assembled state of the gasket through a deformation of the functional layer at least one sealing area with elastic effect can be created; wherein the profiled body is formed by a stopper element and wherein the leveling layer is placed in on a the area of the surface of the functional layer that is facing away from the stopper element.

2. A gasket, according to claim 1 wherein the profiled body comprises incompressible material.

3. A gasket, according to claim 1 wherein the profiled body comprises metal.

4. A gasket, according to claim 1 wherein the profiled body comprises plastic.

5. A gasket, according to claim 1 wherein the stopper element is formed by a separate ring element.

6. A gasket, according to claim 1 wherein the stopper element is created through the flanging of a ring element.

7. A gasket, according to claim 1 wherein the stopper element is placed between two functional layers where at least one leveling layer is placed on the surface of the functional layer facing away from the stopper element.

8. A gasket, according to claim 1 wherein the profiled body is located in at least one leveling layer and/or cover layer on the side of the functional layer where, in the assembled state of the gasket, a corresponding elastic sealing area can be created in the functional layer (4) through the deformation of the functional layer.

9. A gasket, according to claim 1 wherein the profiled body shows such a contour that in the corresponding functional layer at least one half bead-like area can be created.

10. A gasket, according to claim 1 wherein the profiled body shows such a contour that in the corresponding functional layer at least one full bead-like area.

11. A metal gasket, comprising in particular a cylinder head gasket for internal combustion engines, comprising at least one functional layer showing at least one through-opening, as well as at least one leveling layer and/or cover layer that covers the functional layer at least partially; where the functional layer, in the pre-assembled state of the gasket is formed as a flat piece of metal to which is assigned, at least in the area of the through-opening, at least one profiled body, through which in the assembled state of the gasket a deformation of the functional layer at least one sealing area with elastic effect can be created where at least one elevation and at least one cutout associated with the elevation are provided in the leveling layers and/or cover layers, located opposite each other; where the functional layer that is placed in between, and that is initially flat, and that in the assembled state is, at least in this area, deformable while building an elastic sealing area wherein the respective functional layer and the plane of the stopper element shows at least one leveling layer.

12. A gasket, according to claim 11 wherein the functional layer comprises spring steel.
